(19) United States
(12) Patent Application Publication
(10) Pub. No.: US 2021/0276215 A1
(43) Pub. Date: Sep. 9, 2021

(54) Drywall Punch Device

(71) Applicant: Dylan Treivush, West Hollywood, CA (US)

(72) Inventor: Dylan Treivush, West Hollywood, CA (US)

(21) Appl. No.: 16/807,503

(22) Filed: Mar. 3, 2020

(51) Int. Cl. B26F 1/34; B26F 1/40; B26F 1/44

(52) U.S. Cl. CPC B26F 1/34; B26F 1/44; B26F 1/40

(57) ABSTRACT

A drywall punch device for creating holes in a drywall panel includes an actuator that is coupled to and positioned in a housing. A ram that is positioned in the housing between the actuator and a first end of the housing is operationally coupled to the actuator. Each of a set of cutters has a respective shape so that the set of cutters comprises cutters that have a variety of shapes. The cutter is selectively couplable to the first end of the housing so that the cutter is selectively extensible from the housing. The cutter is configured to be positioned in abutment to a drywall panel. The actuator is positioned to selectively propel the ram into the cutter so that the cutter extends from the housing and penetrates the drywall panel to create an aperture that corresponds to the respective shape of the cutter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to punch devices and more particularly pertains to a new punch device for creating holes in a drywall panel.

### (2) Description of Related Art Including Information Disclosed Under 37 CFR 1.97 and 1.98

The prior art relates to punch devices. Prior art devices for creating holes in a drywall panel may comprise a plurality of oscillating teeth arrayed on a perimeter of a cutting tool that is shaped to provide a desired hole pattern.

### BRIEF SUMMARY OF THE INVENTION

An embodiment of the disclosure meets the needs presented above by generally comprising a housing that defines an interior space. An actuator is coupled to the housing and positioned in the interior space. A ram that is positioned in the interior space between the actuator and a first end of the housing is operationally coupled to the actuator. Each of a set of cutters has a respective shape so that the set of cutters comprises cutters that have a variety of shapes. The cutter is selectively couplable to the first end of the housing so that the cutter is selectively extensible from the housing. The cutter is configured to be positioned in abutment to a drywall panel. The actuator is positioned to selectively propel the ram through the interior space into the cutter so that the cutter extends from the housing and penetrates the drywall panel to create an aperture that corresponds to the respective shape of the cutter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a drywall punch device according to an embodiment of the disclosure.

FIG. 2 is a side view of an embodiment of the disclosure.

FIG. 3 is an exploded view of an embodiment of the disclosure.

FIG. 4 is an in-use view of an embodiment of the disclosure.

FIG. 5 is an end view of an embodiment of the disclosure.

FIG. 6 is an isometric perspective view of an embodiment of the disclosure.

### DETAILED DESCRIPTION OF THE INVENTION

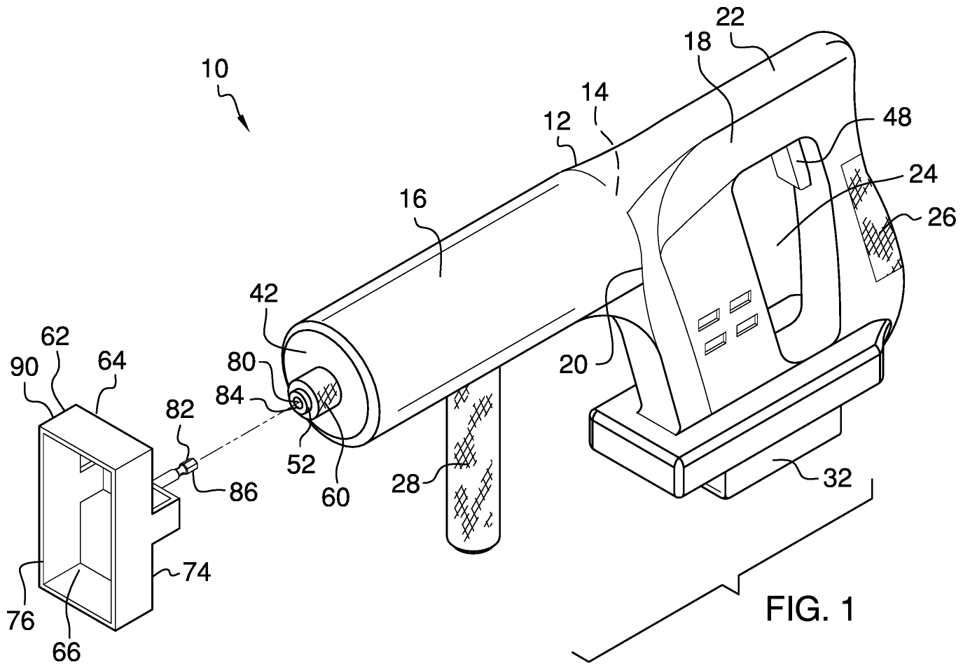

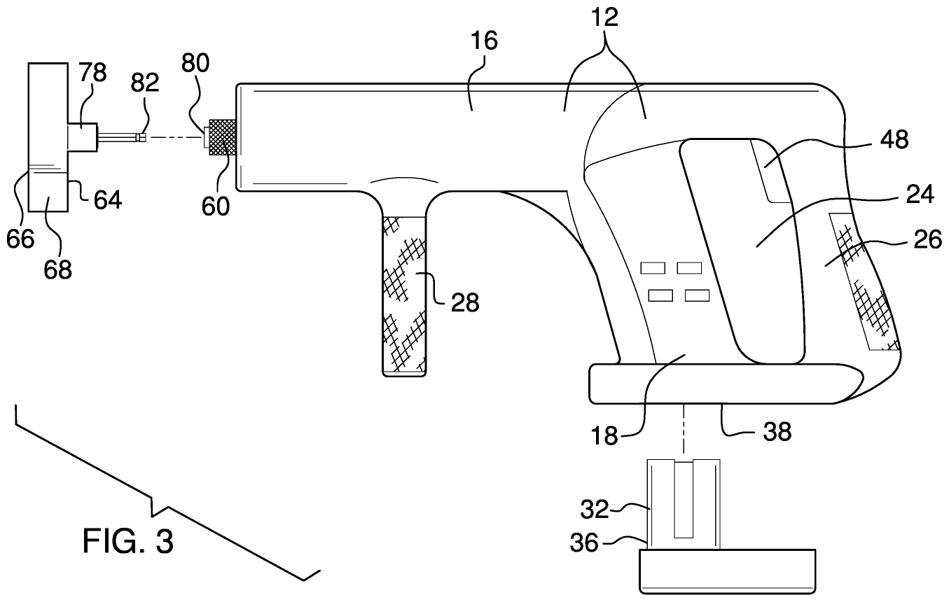

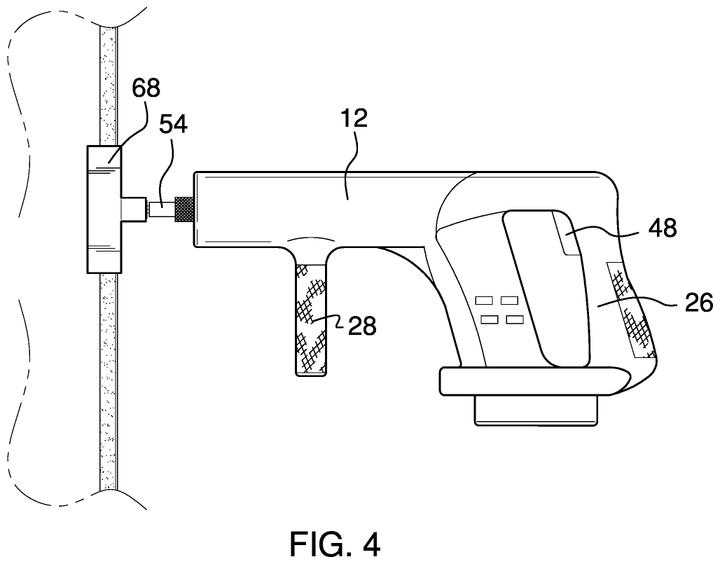

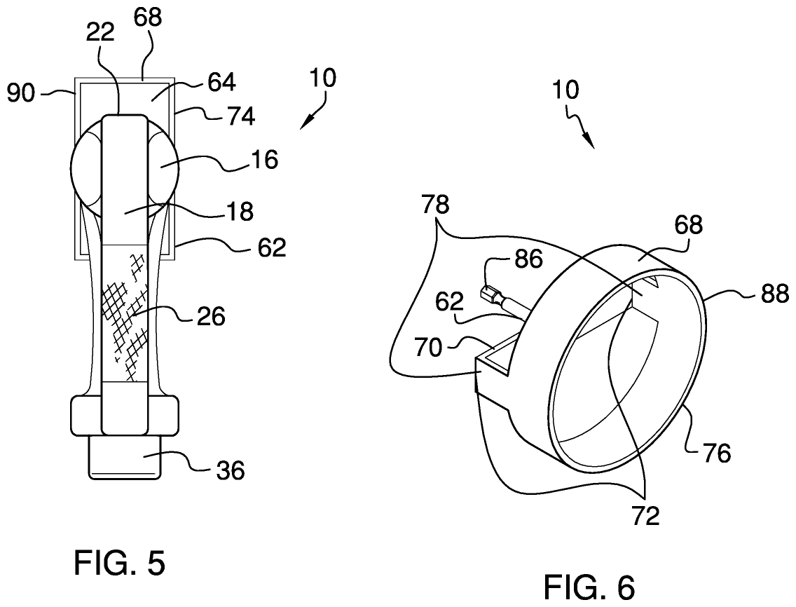

With reference now to the drawings, and in particular to FIGS. 1 through 6 thereof, a new punch device embodying the principles and concepts of an embodiment of the disclosure and generally designated by the reference numeral 10 will be described.

As best illustrated in FIGS. 1 through 6, the drywall punch device 10 generally comprises a housing 12 that defines an interior space 14. The housing 12 comprises a first section 16, which is substantially cylindrically shaped, and a second section 18 that is substantially rectangularly box shaped. The first section 16 extends from a first side 20 of the second section 18 proximate to a top 22 of the second section 18. A cutout 24 that is positioned in the second section 18 of the housing 12 defines a grip 26. The cutout 24 is configured to allow insertion of digits of a first hand of a user, positioning the user to grasp the grip 26 to lift and to position the housing 12.

A handle 28 is coupled to and extends from the first section 16 of the housing 12. The handle 28 is substantially parallel to and coplanar with the second section 18 of the housing 12. The handle 28 is configured to be grasped in a second hand of the user to increase control of the user in positioning the housing 12.

An actuator 30 is coupled to the housing 12 and positioned in the interior space 14. The actuator 30 comprises a power module 32 that is operationally coupled to a motor 34. The power module 32 may comprise a battery 36 that is positioned in the second section 18 of the housing 12. The battery 36 may be rechargeable and at least partially selectively insertable into the housing 12 through an orifice 38 that is positioned in the second section 18 of the housing 12.

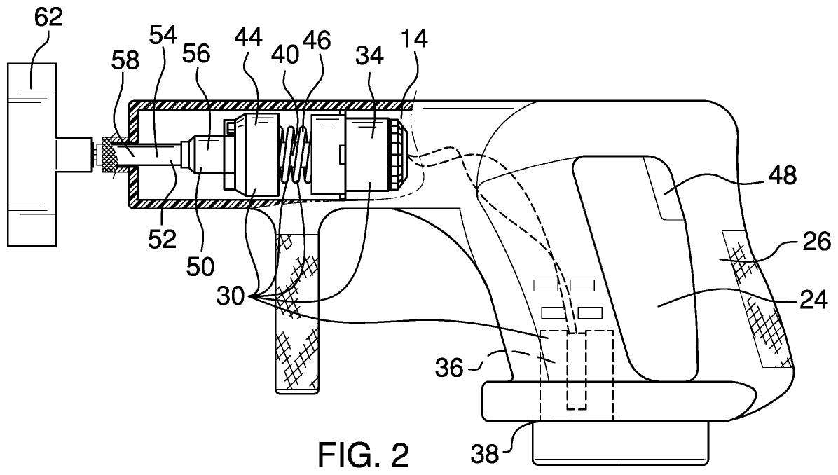

A rod 40 is coupled to and extends from the motor 34 toward a first end 42 of the housing 12. A disc 44 is slidably coupled to the rod 40. A spring 46 that is positioned around the rod 40 is coupled to the disc 44 and selectively couplable to the motor 34. The motor 34 is positioned to tension the spring 46 to motivate the disc 44 along the rod 40 toward the motor 34 and to release the spring 46 so that the spring 46 rebounds to forcefully propel the disc 44 toward the first end 42 of the housing 12. A switch 48 that is operationally coupled to the motor 34 is configured to be selectively switched to actuate the motor 34. The switch 48 is may be trigger type and coupled to the grip 26, as shown in FIG. 2. The switch 48 also may be of other types, such as, but not limited to, push button type, toggle type, and the like.

As described in the above paragraphs, the actuator 30 is mechanically comparable to an electric nailgun. The present invention also anticipates the actuator 30 comprising other actuating means that would render it mechanically comparable to other nailgun types, such as, but not limited to, pneumatic type, powder actuated type, combustion powered type, and solenoid powered type.

A ram 50 that is positioned in the interior space 14 between the actuator 30 and the first end 42 of the housing 12 is operationally coupled to the actuator 30. The actuator 30 is positioned to selectively motivate the ram 50 through the interior space 14 toward the first end 42 of the housing 12.

The ram 50 comprises a bar 52 that positioned in the interior space 14 between the disc 44 and the first end 42 of the housing 12. The bar 52, which is cylindrically shaped, comprises a first segment 54 and a second segment 56. The first segment 54 is selectively extendable from the housing 12 through a hole 58 that is positioned in the first end 42 of the housing 12. The second segment 56 is positioned within the housing 12 and is circumferentially larger than the hole 58 so that the second segment 56 is retained within the interior space 14. A tube 60 is coupled to the housing 12 and extends from the hole 58 so that the tube is positioned to stabilize the bar 52.

Each of a set of cutters 62 has a respective shape so that the set of cutters 62 comprises cutters 62 that have a variety of shapes, as shown in FIG. 6. The cutter 62 is selectively couplable by a first face 64 to the first end 42 of the housing 12 so that the cutter 62 is selectively extensible from the housing 12. A second face 66 of the cutter 62 is configured to be positioned in abutment to a drywall panel. The actuator 30 is positioned to selectively propel the ram 50 through the interior space 14 into the cutter 62 so that the cutter 62 extends from the housing 12 and penetrates the drywall panel to create an aperture that corresponds to the respective shape of the cutter 62.

Each cutter 62 comprises a ring 68 and a first plate 70. The first plate 70 has opposing ends 72 that are coupled to the ring 68 so that the opposing ends 72 are opposingly positioned on a circumference 74 of the first face 64 of the cutter 62. A perimeter 76 of the second face 66 of the cutter 62 may be beveled to facilitate penetration of the ring 68 into the drywall panel.

Each of a pair of second plates 78 is coupled to and positioned between the ring 68 and a respective opposing end 72 of the first plate 70 so that the first plate 70 is positioned distal to and parallel to the first face 64 of the cutter 62. The first plate 70 being distal to the first face 64 of the cutter 62 facilitates removal of drywall that is positioned in the ring 68. The second plates 78 also effectively increase a punching depth of the cutter 62, which is beneficial when creating penetrations in thick drywall panels or multiple layers of drywall panel. The switch 48 can be repeatably switched, if required, to drive the ring 68 through the thick drywall panels or the multiple layers of drywall panel.

A first fastener 80 is coupled to the first section 16 of the bar 52. A second fastener 82 is coupled to the ring 68. The second fastener 82 is complementary to the first fastener 80 so that the second fastener 82 is positioned to selectively couple to the first fastener 80 to removably couple the ring 68 to the bar 52. The first fastener 80 may comprise a channel 84 that extends into the first section 16 of the bar 52. The second fastener 82 may comprise a shaft 86 that is coupled to and extends from the first plate 70. The shaft 86 is complementary to the channel 84 so that the channel 84 is positioned to be inserted the shaft 86 to removably couple the ring 68 to the bar 52. The channel 84 may be hexagonally shaped when viewed longitudinally, as shown in FIG. 1, or alternatively shaped, such as squarely shaped, pentagonally shaped, and the like. The channel 84 being noncircular prevents rotation of the shaft 86 within the channel 84. The present invention anticipates the first fastener 80 and second fastener 82 comprising other fastening means, such as, but not limited to, clamps, set screws, quick connects, and the like.

The set of cutters 62 comprises a first cutter 88, which is circularly shaped, and a second cutter 90 that is rectangularly shaped. The first cutter 88 is utilized when a circular penetration is required. The present invention anticipates the first cutter 88 having a variety of sizes appropriate for creating penetrations sized for piping, electrical ceiling boxes, and the like. The second cutter 90 is utilized when a rectangular penetration is required. The present invention also anticipates the second cutter 90 having a variety of sizes appropriate for creating penetrations sized for single gang, double gang, triple gang, and quadruple gang electrical boxes used for switches, outlets, and the like.

In use, the cutter 62 is coupled to the bar 52 by inserting the shaft 86 into the channel 84. The second face 66 of the cutter 62 then is positioned in abutment to the drywall panel where the penetration is desired. The user then applies force to the housing 12 through the grip 26 and the handle 28 to stabilize the cutter 62 against the drywall panel and to prevent recoil. The switch 48 is then switched to actuate the motor 34 to first tension and then release the spring 46, causing the disc 44 to strike the bar 52 to drive the ring 68 through the drywall panel to create the penetration.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A drywall punch device comprising:
a housing defining an interior space;
an actuator coupled to the housing and positioned in the interior space;
a ram positioned in the interior space between the actuator and a first end of the housing, the ram being operationally coupled to the actuator such that the actuator is positioned for selectively motivating the ram through the interior space toward the first end of the housing; and
a set of cutters, each cutter having a respective shape such that the set of cutters comprises cutters having a variety of shapes, the cutter being selectively couplable by a first face to the first end of the housing such that the cutter is selectively extensible from the housing wherein a second face of the cutter is configured for positioning in abutment to a drywall panel positioning the actuator for propelling the ram into the cutter such that the cutter extends from the housing and penetrates the drywall panel for creating an aperture in the drywall panel corresponding to the respective shape of the cutter.

2. The device of claim 1, further comprising:
the housing comprising a first section and a second section, the first section being substantially cylindrically shaped, the second section being substantially rectangularly box shaped, the first section extending from a first side of the second section proximate to a top of the second section; and
a cutout positioned in the second section of the housing defining a grip wherein the cutout is configured for inserting digits of a first hand of a user positioning the user for grasping the grip for lifting and positioning the housing.

3. The device of claim 2, further including a handle coupled to and extending from the first section of the housing, the handle being substantially parallel to and coplanar with the second section of the housing wherein the handle is configured for grasping in a second hand of the user for increasing control of the user in positioning the housing.

4. The device of claim 2, further including the actuator comprising:
a power module;
a motor operationally coupled to the power module;
a rod coupled to and extending from the motor toward the first end of the housing;
a switch operationally coupled to the motor wherein the switch is configured for selectively switching for actuating the motor;
a disc slidably coupled to the rod; and
a spring positioned around the rod, the spring being coupled to the disc and selectively couplable to the motor such that the motor is positioned for tensioning the spring for motivating the disc along the rod toward the motor and such that the motor is positioned for releasing the spring such that the spring rebounds for forcefully propelling the disc toward the first end of the housing.

5. The device of claim 4, further including the power module comprising a battery positioned in the second section of the housing, the battery being rechargeable.

6. The device of claim 5, further including the battery being at least partially selectively insertable into the housing through an orifice positioned in the second section of the housing.

7. The device of claim 4, further including the switch being trigger type, the switch being coupled to the grip.

8. The device of claim 4, further comprising:
the ram comprising a bar positioned in the interior space between the disc and the first end of the housing, the bar being cylindrically shaped, the bar comprising a first segment and a second segment, the first segment being selectively extendable from the housing through a hole positioned in the first end of the housing, the second segment being positioned within the housing, the second segment being circumferentially larger than the hole such that the second segment is retained within the interior space;
each cutter comprising a ring and a first plate, the first plate having opposing ends coupled to the ring such that the opposing ends are opposingly positioned on a circumference of the first face of the cutter;
a first fastener coupled to the first segment of the bar; and
a second fastener coupled to the ring, the second fastener being complementary to the first fastener such that the second fastener is positioned for selectively coupling to the first fastener for removably coupling the ring to the bar.

9. The device of claim 8, further including a tube coupled to the housing and extending from the hole such that the tube is positioned for stabilizing the bar.

10. The device of claim 1, further including the set of cutters comprising a first cutter and a second cutter, the first cutter being circularly shaped, the second cutter being rectangularly shaped.

11. The device of claim 8, further including a pair of second plates, each second plate being coupled to and positioned between the ring and a respective opposing end of the first plate such that the first plate is positioned distal to and parallel to the first face of the cutter.

12. The device of claim 11, further comprising:
the first fastener comprising a channel extending into the first segment of the bar, the channel being hexagonally shaped when viewed longitudinally; and
the second fastener comprising a shaft coupled to and extending from the first plate, the shaft being complementary to the channel such that the channel is positioned for inserting the shaft for removably coupling the ring to the bar.

13. A drywall punch device comprising:
a housing defining an interior space, the housing comprising a first section and a second section, the first section being substantially cylindrically shaped, the second section being substantially rectangularly box shaped, the first section extending from a first side of the second section proximate to a top of the second section;
a cutout positioned in the second section of the housing defining a grip wherein the cutout is configured for inserting digits of a first hand of a user positioning the user for grasping the grip for lifting and positioning the housing;
a handle coupled to and extending from the first section of the housing, the handle being substantially parallel to and coplanar with the second section of the housing wherein the handle is configured for grasping in a second hand of the user for increasing control of the user in positioning the housing;
an actuator coupled to the housing and positioned in the interior space, the actuator comprising:
a power module, the power module comprising a battery positioned in the second section of the housing, the battery being rechargeable, the battery being at least partially selectively insertable into the housing through an orifice positioned in the second section of the housing,
a motor operationally coupled to the power module,
a rod coupled to and extending from the motor toward a first end of the housing,
a switch operationally coupled to the motor wherein the switch is configured for selectively switching for actuating the motor, the switch being trigger type, the switch being coupled to the grip,
a disc slidably coupled to the rod, and
a spring positioned around the rod, the spring being coupled to the disc and selectively couplable to the motor such that the motor is positioned for tensioning the spring for motivating the disc along the rod toward the motor and such that the motor is positioned for releasing the spring such that the spring rebounds for forcefully propelling the disc toward the first end of the housing;
a ram positioned in the interior space between the actuator and the first end of the housing, the ram being operationally coupled to the actuator such that the actuator is positioned for selectively motivating the ram through the interior space toward the first end of the housing, the ram comprising a bar positioned in the interior space between the disc and the first end of the housing, the bar being cylindrically shaped, the bar comprising a first segment and a second segment, the first segment being selectively extendable from the housing through a hole positioned in the first end of the housing, the second segment being positioned within the housing, the second segment being circumferentially larger than the hole such that the second segment is retained within the interior space;
a tube coupled to the housing and extending from the hole such that the tube is positioned for stabilizing the bar;
a set of cutters, each cutter having a respective shape such that the set of cutters comprises cutters having a variety of shapes, the cutter being selectively couplable by a first face to the first end of the housing such that the cutter is selectively extensible from the housing wherein a second face of the cutter is configured for positioning in abutment to a drywall panel positioning the actuator for propelling the ram into the cutter such that the cutter extends from the housing and penetrates the drywall panel for creating an aperture in the drywall panel corresponding to the respective shape of the cutter, each cutter comprising a ring and a first plate, the first plate having opposing ends coupled to the ring such that the opposing ends are opposingly positioned on a circumference of the first face of the cutter, the set of cutters comprising a first cutter and a second cutter, the first cutter being circularly shaped, the second cutter being rectangularly shaped;
a pair of second plates, each second plate being coupled to and positioned between the ring and a respective opposing end of the first plate such that the first plate is positioned distal to and parallel to the first face of the cutter;
a first fastener coupled to the first segment of the bar, the first fastener comprising a channel extending into the first segment of the bar, the channel being hexagonally shaped when viewed longitudinally; and
a second fastener coupled to the ring, the second fastener being complementary to the first fastener such that the second fastener is positioned for selectively coupling to the first fastener for removably coupling the ring to the bar, the second fastener comprising a shaft coupled to and extending from the first plate, the shaft being complementary to the channel such that the channel is positioned for inserting the shaft for removably coupling the ring to the bar.
